(19) United States
(12) Patent Application Publication
(10) Pub. No.: US 2006/0160237 A1
(43) Pub. Date: Jul. 20, 2006

(54) Method of screening urine for organic acids

(75) Inventor: Yinghua A. Du, Palo Alto, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 11/296,646

(22) Filed: Dec. 6, 2005

Related U.S. Application Data
(60) Provisional application No. 60/634,006, filed on Dec. 6, 2004.

(51) Int. Cl. G01N 30/00

(52) U.S. Cl. 436/129; 436/161

(57) ABSTRACT

The present teachings relate to systems and screening methods for measuring organic acids in urine samples.

This application claims a priority benefit of U.S. Patent Application No. 60/634,006, filed Dec. 6, 2004, which is incorporated herein by reference.

The present teachings relate to systems and screening methods for measuring organic acids in urine samples.

Approximately 4 million newborns in the United States have dried blood spots analyzed through newborn (e.g.—an infant aged ≦1 month) screening programs each year. Such screening programs are intended to detect inborn disorders that can result in early mortality or lifelong disability. Among the inborn disorders that newborn screening programs are designed to detect are inborn errors of metabolism (also commonly referred to as IEMs, organic acidemias, organic acidurias and/or metabolic disorders).

A common screening method for organic acids in urine uses GC/MS. In GC/MS screening, organic acids are chromatographically separated on the basis of their polarity and volatility and them bombarded by an electron beam that fragments the eluting molecules in a pattern that is characteristic of each organic acid. However, before the GC/MS analysis of a urine sample can be performed, the organic acids must first be extracted from the urine sample and then chemically modified to make the organic acids sufficiently volatile for GC/MS analysis. One such derivitization includes reaction of a mixture of organic acids with bis-trimethysilyl-trifluoroacetamide (BSTFA) and 1% trimethylchlorosilane (TMSCI) to form trimethylsilyl (TMS) ethers and esters of alcohol, acid, and sulfhydryl substituents on the organic acids. The GC/MS screening method is undesirable due to the need for the costly and labor-intensive extraction and derivitization of the organic acids from the urine sample prior to analysis on the GC/MS.

In some embodiments, the present teachings provide for a method of screening for organic acid markers of metabolic disorders in a urine sample comprising, loading an aliquot of the sample on an HPLC-MS-MS operating in multiple reaction mode, measuring at least 50 organic acid markers of metabolic disorders in a single HPLC-MS-MS run by monitoring the molecular ion peak or at least one daughter ion peak for each organic acid, wherein the sample is analyzed without derivitization of the organic acids.

In some embodiments, the present teachings provide for a method of diagnosing in born errors of metabolism comprising, loading an aliquot of a urine sample on an HPLC-MS-MS operating in multiple reaction mode and measuring a molecular ion peak or at least one daughter ion peak of at least 50 organic acids in a single HPLC-MS-MS run, wherein the molecular ion peak and the daughter ion peak are selected from a database comprising the fragmentation patterns of at least 50 organic acid markers for inborn errors of metabolism and the sample is analyzed without derivitization of the organic acids.

In some embodiments, the present teachings provide for a method of measuring organic acid in a urine sample comprising, providing a urine sample comprising at least 50 different nonderivitized organic acids, and chromatographing the sample on an HPLC column of an HPLC-MS-MS system such that effluent from the HPLC column is fed into the MS-MS portion of the system, whereby the levels of at least 50 different organic acids can be measured in a single mass spectrometer run of the chromatographed sample.

A method of screening for organic acid markers of metabolic disorders in a urine sample comprising, providing a urine sample comprising at least 50 different nonderivitized organic acids, and chromatographing the sample on an HPLC column of an HPLC-MS-MS system such that effluent from the HPLC column is fed into the MS-MS portion of the system, whereby the levels of at least 50 different organic acids can be measured in a single mass spectrometer run of the chromatographed sample.

In some embodiments, said measuring comprises measuring at least one representative ion peak for each organic acid. In some embodiments, each representative ion peak is a parent ion or a daughter ion. In some embodiments, at least 40 of said different organic acids are markers of metabolic disorders, and the method further comprises comparing the measured level of at least one measured organic acid with a normal level, such that a non-normal level of a measured organic acid indicates the presence or status of a metabolic disorder.

In some embodiments, the present teachings provide for a method further comprises monitoring one or more metabolic disorders in a patient by applying the method of claim 1 to at least two urine samples collected from the patient at different times.

In some embodiments, the present teachings provide for methods further comprising, prior to the step of loading, centrifuging the urine sample. In some embodiments, the present teachings provide for methods further comprising, comparing the measured amount of each organic acid in the sample with a normal amount of each organic acid.

In some embodiments, the present teachings provide a system for detecting organic acid markers of metabolic disorders without derivitization comprising, an HPLC-MS-MS system and a database comprising the fragmentation patterns of at least 50 organic acid markers for metabolic disorders.

It is to be understood that both the foregoing general description and the following detailed description are exemplary and explanatory only and are not restrictive of the present teachings. In this application, the use of the singular includes the plural unless specifically stated otherwise. In this application, the use of “or” means “and/or” unless stated otherwise. Furthermore, the use of the term “comprising,” as well as other forms, such as “comprises” and “comprised,” is not limiting.

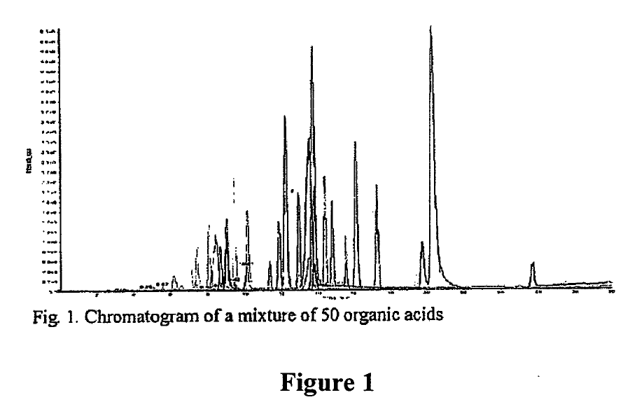

FIG. 1 shows an LC-MS-MS plot of 50 organic acids simultaneously detected in a urine sample by methods of the present teachings.

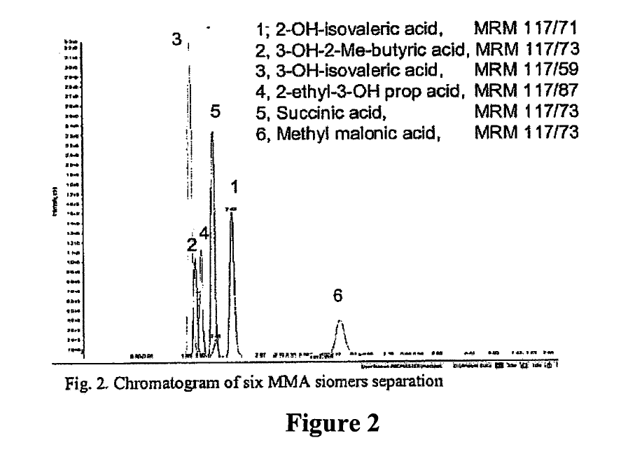

FIG. 2 shows an LC-MS-MS plot of 6 isomeric organic acids simultaneously detected from a urine sample by methods of the present teachings and having the same molecular ion peak.

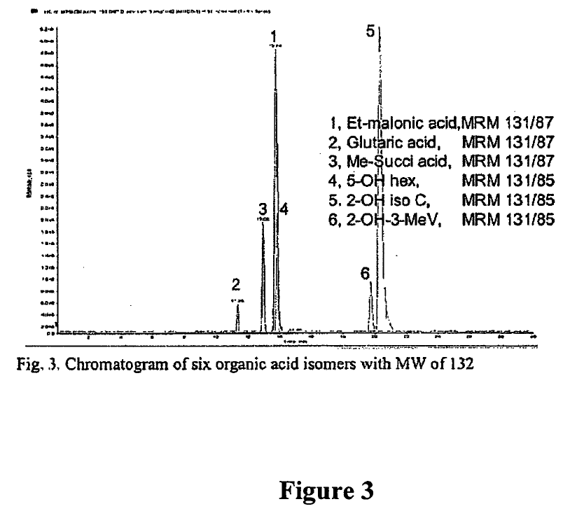

FIG. 3 shows an LC-MS-MS plot of 6 isomeric organic acids simultaneously detected from a urine sample by methods of the present teachings and having the same molecular ion peak.

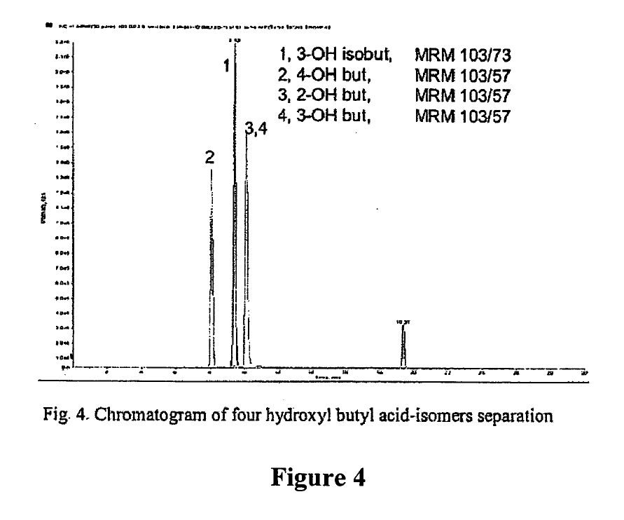

FIG. 4 shows an LC-MS-MS plot of 4 isomeric organic acids simultaneously detected from a urine sample by methods of the present teachings and having the same molecular ion peak.

In some embodiments, the present teachings provide for a method of screening for organic acid markers of metabolic disorders in a urine sample comprising, loading an aliquot of the sample on an HPLC-MS-MS operating in multiple reaction mode, measuring at least 50 organic acid markers of metabolic disorders in a single HPLC-MS-MS run by monitoring the molecular ion peak or at least one daughter ion peak of each organic acid, wherein the sample is analyzed without derivitization of the organic acids.

As used herein, “multiple reaction mode” refers to an MS-MS experiment where one or more specific products of a selected precursor ion (i.e.- a parent ion, a molecular ion or a daughter ion) is monitored.

As used herein, “without derivitization” means that for example, a urine sample in which the organic acids contained therein or to be measured have not been covalently modified (e.g., by methylation).

As used herein, “fragmentation pattern” refers to the entire mass spectrum of an analyte, including all daughter ions, and alternatively “fragmentation pattern” refers to some subset of peaks in the mass spectrum of an analyte, and may include the molecular ion peak, the parent ion peak and daughter ions, where a “subset” means at least one peak.

It will be understood that numerous metabolic diseases, disorders and deficiencies can be detected and/or diagnosed by the methods of the present teachings. Examples of classes of diseases that can be detected by organic acid analysis include, but are not limited to, diseases of aromatic amino acid metabolism, diseases of branched chain amino acid metabolism, diseases of cholesterol synthesis, diseases of pyrimidine metabolism, diseases of purine metabolism, diseases that are associated with lactic acidemia and/or pyruvic acidemia, diseases of fatty acid oxidation, Kreb's cycle/respiratory chain disorders, diseases of lactic acid metabolism, diseases of lysine, glycine and serine metabolism, and the like.

Examples of diseases that can be categorized under the above classes include, but are not limited to, phenylketonuria (PKU), tetrahydrobiopterin (BH4) deficiency, tyrosinemia, tyrosinemia (hepatorenal form), Zellweger disease, Hawkinsinuria, lactic acidosis, alcaptonuria, maple syrup urine disease (MSUD), dihydrolipoyl dehydrogenase (E3) deficiency, multiple acyl dehydrogenase (MAD) deficiency (also known as glutaric acidemia type II), lactic acidosis, mitochondrial acetoacetyl-coenzyme A (CoA)-thiolase deficiency, isovaleric acidemia (IVA), cytosolic acetoacetyl-CoA thiolase deficiency, methylcrotonylglycinuria, 3-methyl glutanoic aciduria (type II), respiratory chain defects (e.g.- Complex I, Complex II, Pearson syndrome or mitochondrial ATP synthase deificiency), 2-methyl-3-hydroxybutyryl-CoA dehydrogenase deficiency, HMG-CoA lyase deficiency, 3-methylcrotonyl-CoA carboxylase deficiency, succinyl-CoA:3-oxoacid-CoA transferase deficiency, succinic semialdehyde dehydrogenase deficiency, methylmalonic semialdehyde dehydrogenase deficiency, biotin-responsive multiple carboxylase deficiency, 2-oxoadipic aciduria, 3-methylglutaconic aciduria, 3-hydroxy-3-methyl glutaric aciduria, P-ketothiolase deficiency, Smith-Lemil-Opitz syndrome, carbamyl phosphate synthetase deficiency, transcobalamine II deficiency, malonic aciduria, propionic acidemia (PA), methylmalonic acidemia (MMA), 2-ketoadipic acidura, glutaric aciduria type I, 5-oxoprolinuria, omithine transcarbamylase deficiency, citrullinemia, arginosuccinic aciduria, arginemia, Canavan's disease, methioninemia, Lesch-Nyhan's syndrome, orotic aciduria, short chain fatty acyl dehydrogenase deficiency (SCAD), medium chain fatty acyl dehydrogenase deficiency (MCAD), long chain fatty acyl dehydrogenase deficiency (LCAD), variable length chain fatty acyl dehydrogenase deficiency (VLCAD), short chain 3-hydroxyacyl dehydrogenase deficiency (SCHAD), long chain 3-hydroxyacyl dehydrogenase deficiency (LCHAD), hyperornithineia-hyperammonemia-homocitrullinuria (HHH) syndrome, 3-oxothiolase deficiency, malonoyl-CoA decarboxylase deficiency, 3-oxoacid-CoA transferase deficiency, mevalonic acidemia, 5-oxoprolinuria, lactose intolerance, D-glyceric aciduria, pyruvic carboxylase deficiency (neonatal and infantile forms), phosphoenol pyruvic carboxykinase deficiency, hydroxyprolinemia, tryptophanuria, hyperglycinuria, NADH-CoQ oxidoreductase (Complex I) deficiency, lysinuric protein intolerance, ubiquinol-cytochrome C reductase (Complex III) deficiency, cytochrome oxidase (Complex IV) deficiency, myoclonic epilepsy with ragged-red fibers (MERRF), mitochondrial encephalomyopathy lactic acidosis with stroke-like episodes (MELAS) Keams-Sayre syndrome, glutathione synthetase deficiency, fumarase deficiency, succinic semialdehyde dehydrogenase deficiency with lactic acidosis, pyruvate dehydrogenase (PDH) complex (E1, E3) deficiency, biotinidase deficiency, alpha-ketoglutaric aciduria, pyruvic dehydrogenase phosphatase deficiency, primary hyperoxaluria type I and II, long chain acyl-CoA dehydrogenase deficiency, medium chain acyl-CoA dehydrogenase deficiency, short chain acyl-CoA dehydrogenase deficiency, multiple acyl-CoA dehydrogenase deficiency, lysine malabsorption, prolidase deficiency, formiminoglutamic aciduria, renal Fanconi's histidinemia, pyruvate carboxylase deficiency, hyper-β-alaninemia, aminoadipic aciduria, β-aminoisobutyric aciduria, hyperomitinemia, cystinuria, hyperdibasicaminoaciduria, oasthouse urine disease (also known as methionine malabsorption syndrome), argininosuccinate synthase deficiency, Hartnup's disease, fructose 1,6-diphosphatase deficiency, ethylmalonic-adipic acidemia, systemic carnitine deficiency, carnitine palmitoyl transferase deficiency type II (CPT II), 4-hydroxybutyric aciduria, fumaric aciduria, peroxisomal diseases, argininemia, orotidine ornithine carbamoyltransferase deficiency, ethylmalonic aciduria (EMA aciduria), nonketotic dicarboxyluria, glycogen storage disorders I & II, neuroblastoma, carcinoid syndrome, pheochromacytoma, and the like. It will be understood that other diseases, disorders and deficiencies related to errors of metabolism have been identified that can be detected and/or diagnosed by measuring organic acids in urine. For more comprehensive reviews on metabolic disorders and/or diseases see, for example, The Metabolic and Molecular Basis of Inherited Disease, 7^{th} Ed., Scriver, C. R., Beaudet, A. L., Sly, W. S. and Valle, D., Eds., 1995, McGraw-Hill (New York, N.Y.); Blau, N. Physician's Guide to the Laboratory Diagnosis of Metabolic Diseases, 1996, Chapman & Hall (London, UK) and Nyhan, W. L., MD and Ozand, P. T., MD, Atlas of Metabolic Diseases, 1996, Chapman & Hall (London, UK).

It will be understood that a wide range of organic acids can be identified in urine as markers for metabolic disorders and diseases. In some embodiments, the presence or absence of organic acids such as those shown in Table 1 can be determined according to methods of the present teachings.

TABLE 1

| | Molecular | Exemplary | |
|---|---|---|---|
| Organic Acid | weight | Reference Value⁽¹⁾ | Exemplary Disorder⁽³⁾ |
| Glyoxylic acid | 74 | 1.7 | Hyperoxaluria I |
| Pyruvic acid | 88 | 27.8 | Dihydrolipoyl (E3) dehydrogenase |
| | | | deficiency |
| 3-Hydroxypropionic acid | 90 | <24 | PA |
| Lactic acid | 90 | <197 | Dihydrolipoyl (E3) dehydrogenase |
| | | | deficiency |
| Acetoacetic acid | 102 | 0.1 | β-ketothiolase deficiency⁽⁴⁾ |
| 2-Oxobutyric acid | 102 | 10.5 | |
| 3-Hydroxyisobutyric acid | 104 | <24 | 3-Hydroxyisobutyric aciduria |
| 4-Hydroxybutyric acid | 104 | <9.5 | Succinic semialdehyde dehydrogenase |
| | | | deficiency⁽⁵⁾ |
| 2-Hydroxybutyric acid | 104 | 0.2 | MAD⁽⁶⁾ |
| 3-Hydroxybutyric acid | 104 | 1.9 | Cytosolic acetoacetyl-CoA thiolase |
| | | | deficiency⁽⁵⁾ |
| Fumaric acid | 116 | <100 | Fumaric aciduria |
| 2-Oxoisovaleric acid | 116 | <2 | MSUD |
| Hexanoic acid | 116 | 0.03 | MCAD |
| Methylmalonic acid | 118 | <2 | MMA |
| Succinic acid | 118 | 39.8 | PDH complex (E1, E3) deficiency⁽⁴⁾ |
| 2-Ethyl-3-hydroxypropionic acid | 118 | 0.8 | 3-Hydroxyisobutyric aciduria |
| 3-Hydroxyisovaleric acid | 118 | <2 | IVA |
| 2-Methyl-3-hydroxybutyric acid | 118 | <2 | 3-Oxothiolase deficiency |
| 2-Hydroxyisovaleric acid | 118 | <2 | MSUD |
| Glutaconic acid | 130 | 0.9 | Glutaric aciduria type I |
| 2-Oxoisocaproic acid | 130 | <2 | Lactic acidemia⁽⁶⁾ |
| 2-Oxo-3-methylvaleric acid | 130 | <2 | MSUD |
| Ethylmalonic acid | 132 | <10 | MAD |
| Glutaric acid | 132 | <4 | Glutaric aciduria type I II & III |
| Methylsuccinic acid | 132 | <3 | SCAD |
| 5-Hydroxyhexanoic acid | 132 | <7 | MCAD |
| 2-Hydroxyisocaprioc acid | 132 | <2 | MSUD |
| 2-Hydroxy-3-methylvaleric acid | 132 | <2 | Dihydrolipoyl (E3) dehydrogenase |
| | | | deficiency |
| 3-Methylglutaconic acid | 144 | <9 | 3-Methylglutaconic acidemia |
| Octanoic acid | 144 | 0.3 | MCAD |
| Isobutyrylglycine | 145 | <2 | 3-Hydroxyisobutyric aciduria |
| Butyrylglycine | 145 | <7.5⁽²⁾ | VLCAD⁽⁵⁾ |
| 2-Oxoglutaric acid | 146 | 115 | Pyruvate carboxylase deficiency⁽⁶⁾ |
| 3-Methylglutaric acid | 146 | <7 | 3-Methylglutaconic acidemia |
| Mevalonic acid | 148 | <2 | Mevalonic aciduria |
| Orotic acid | 156 | <3 | HHH⁽⁶⁾ |
| Succinylacetone | 158 | <1⁽²⁾ | Tyrosinemia type I |
| 4-Hydroxycyclohexyl acetic acid | 158 | ? | Hawkinsinuria⁽⁴⁾ |
| valerylglycine | 159 | ? | |
| isovalerylglycine | 159 | <10 | IVA |
| 2-Methylbutyrylglycine | 159 | <2.1⁽²⁾ | 2-Methylbranched chain acyl-CoA |
| | | | dehydrogenase deficiency⁽⁵⁾ |
| Aconitic acid | 174 | 23.8 | Pearson syndrome⁽⁴⁾ |
| Hippuric acid | 179 | 48 | |
| Citric acid | 192 | 480 | Dihydrolipoyl (E3) dehydrogenase |
| | | | deficiency⁽⁴⁾ |
| Isocitric acid | 192 | 40.3 | Fumarase deficiency⁽⁴⁾ |
| Methylcitric acid | 206 | <5 | PA |

Notes:
⁽¹⁾Unless otherwise indicated, all reference values are in mmol/mol creatinine; Source: Blau, N. Physician's Guide to the Laboratory Diagnosis of Metabolic Diseases, 1996, Chapman & Hall (London, UK).
⁽²⁾Reference value given in μg/mg creatinine; Source: Specialty Laboratories, 27027 Tourney Rd., Santa Clarita, CA, www.specialtylabs.com.
⁽³⁾Source: unless otherwise indicated Blau, N. Physician's Guide to the Laboratory Diagnosis of Metabolic Diseases, 1996, Chapman & Hall (London, UK).
⁽⁴⁾Source: Kumps, A., et al., Clinical Chemistry, 48(5), 708-717 (2002).
⁽⁵⁾Source: The Metabolic and Molecular Basis of Inherited Disease. 7^{th} Ed., Scriver, C. R., Beaudet, A. L., Sly, W. S. and Valle, D., Eds., 1995, McGraw-Hill (New York, NY).
⁽⁶⁾Source: Nyhan, W. L., MD and Ozand, P. T., MD, Atlas of Metabolic Diseases, 1996, Chapman & Hall (London, UK).

In some embodiments, the presence or absence of at least the 50 organic acids shown in Table 1 can be determined according to methods of the present teachings. In some embodiments, the presence or absence of greater than 50 organic acids can be determined according to methods of the present teachings.

In some embodiments, the 50 organic acids shown in Table 1 can be quantified according to methods of the present teachings. In some embodiments, at least the 50 organic acids shown in Table 1 can be quantified according to methods of the present teachings. In some embodiments, greater than 50 organic acids can be quantified according to methods of the present teachings.

It will be understood that methods of quanititation and calibration of analytes in biological samples is well known in the art. In some embodiments, organic acids in urine samples can be quantitated and reported relative to an external reference standard. Briefly, for example, a calibration curve can be generated using a reference standard by preparing serial dilutions from a stock solution of the reference standard, running the dilutions on an LC-MS-MS system and measuring the peak area or height of the reference standard at the various concentrations. The curve can then be generated by plotting the peak areas or heights obtained from each reference standard run versus the concentrations of the standard. An aliquot of the sample can then be analyzed on the LC-MS-MS system according to methods of the present teachings and the peak areas of each organic acid in the sample compared to the calibration curve to obtain concentrations of each organic acid in the sample.

In some embodiments, organic acids in urine samples can be quantitated relative to an external reference standard and reported in terms of creatinine clearance (i.e.—μmol/mmol creatinine, see exemplary reference values in Table 1). Briefly, the external reference calibration curve can be generated as above, and the sample analyzed according to methods of the present teachings. The creatinine concentration of the urine sample can be determined according to any of a number of methods known in the art including, but not limited to, the Jaffe reaction (also known as the Folin-Wu method), HPLC, enzymatic detection methods, cation exchange chromatography, and the like (see, for example, Folin, O. J.Biol.Chem., 8, 395-397 (1911) and Smith-Palmer, T., J.Chrom. Part B, 781, 93-106 (2002) and references cited therein. After the creatinine concentration has been determined, the organic acid concentrations can be divided by the creatinine concentration to obtain a creatinine-corrected value for each organic acid.

In some embodiments, organic acids in urine samples can be quantitated relative to an internal reference standard and optionally reported in terms of creatinine clearance (i.e.—μmol/mmol creatinine, see exemplary reference values in Table 1). Briefly, for example, a calibration curve can be generated using an internal reference standard as described in paragraph 19. An aliquot of the sample can then be spiked with a known amount of internal reference standard to correspond to a concentration on the calibration curve. The sample can then be analyzed on the LC-MS-MS system according to methods of the present teachings and the peak areas of each organic acid in the sample as well as the internal reference standard compared to the calibration curve to obtain concentrations of each organic acid in the sample. The organic acid concentrations can be adjusted for creatinine concentration as above and reported as a ratio of organic acid concentration to creatinine concentration as in Table 1. Suitable reference standards include, but are not limited to, stable isotope standards of one or more organic acids or a non-naturally occurring organic acid having a unique molecular ion peak or unique daughter ion peak(s).

It will be understood that any high performance liquid chromatography-tandem mass spectrometer (LC-MS-MS) instrument that is capable of operating in multiple reaction mode can be suitable for use in connection with the present teachings. Furthermore, it will be understood that any of a variety of separation columns can be used in the HPLC portion of the LC-MS-MS. For example, a Phenomenex EZ: FAAST 250×3.0 mm, 4 μm AAA-MS column can be use in connection with an Applied Biosystems/MDS Sciex 4000 Q-TRAP LC-MS-MS system to carry out methods of the present teachings. It will be understood that any number of column and LC-MS-MS combinations can be found based on the present teachings that will operate in a similar manner and that one of skill in the art will recognize what systems may be suitable for use in connection with methods of the present teachings. It will be further understood that the methods of the present teachings can be carried out by following standard operational protocols of LC-MS-MS systems operating in multiple reaction mode.

Briefly, methods of the present teachings can be carried out as follows. A urine sample can be obtained from a patient or subject. The sample can optionally be diluted. The sample can optionally be spiked with creatinine and/or an internal reference standard. The sample can optionally be centrifuged before or after dilution and before or after adding creatinine and/or an internal reference standard. The sample can be injected into the HPLC column of an LC-MS-MS system operating in multiple reaction mode under normal or modified operating protocol. And the sample can be monitored for molecular ion peaks and/or daughter ion peaks and/or peak transitions of at least 50 organic acid markers for metabolic disorders.

Experimental evidence has demonstrated that the 50 organic acids shown in Table 1 can be simultaneously detected in an aliquot of a urine sample by methods of the present teachings, see FIG. 1. Experimental evidence has also demonstrated that isomeric organic acids (i.e.- organic acids having the same molecular weight and/or the same molecular ion peak) can be separated and detected by methods of the present teachings, see FIGS. 2-4. Briefly, as shown in FIG. 2, by monitoring one or more daughter ion peaks of isomeric organic acids that are not separable by the HPLC of the LC-MS-MS, the organic acids can be detected and resolved from each other. Specifically, in FIG. 2, 3-hydroxy-2-methylbutyric acid (peak 2), 3-hydroxyisovaleric acid (peak 3) and 2-ethyl-3-hydroxypropionic acid (peak 4) all have the same molecular weight and molecular ion peak (e.g.—M/z =117) and each organic acid has a similar retention time on a Phenomenex EZ: FAAST 250×3.0 mm, 4 μm AAA-MS column. However, by monitoring the molecular ion peak to daughter ion peak transitions (e.g.—for 3-hydroxy-2-methylbutyric acid, 117→73; for 3-hydroxyisovaleric acid, 117→59; and for 2-ethyl-3-hydroxypropionic acid, 117→87) for each of organic acid, the isomeric organic acids can be resolved and detected according to methods of the present teachings.

All documents, or portions of documents, cited in this application, including but not limited to patents, patent applications, articles, books, and treatises, are hereby expressly incorporated by reference in their entirety for any purpose, except that in the event of any inconsistent disclosure or definition from the present application, the disclosure or definition herein shall be deemed to prevail.

The foregoing detailed description, examples, and accompanying drawings have been provided solely by way of explanation and illustration, and are not intended to limit the scope of the appended claims or their equivalents. Many variations in the present teachings illustrated herein will be obvious to one of ordinary skill in the art, and remain within the scope of the appended claims and their equivalents.

1. A method of measuring organic acid in a urine sample comprising:
i) providing a urine sample comprising at least 50 different nonderivitized organic acids, and
ii) chromatographing the sample on an HPLC column of an HPLC-MS-MS system such that effluent from the HPLC column is fed into the MS-MS portion of the system,
whereby the levels of at least 50 different organic acids can be measured in a single mass spectrometer run of the chromatographed sample.

2. The method of claim 1, wherein said measuring comprises measuring at least one representative ion peak for each organic acid.

3. The method of claim 2, wherein each representative ion peak is a parent ion or a daughter ion.

4. The method of any of the preceding claims wherein at least 40 of said different organic acids are markers of metabolic disorders, and the method further comprises comparing the measured level of at least one measured organic acid with a normal level, such that a non-normal level of a measured organic acid indicates the presence or status of a metabolic disorder.

5. The method of any of the preceding claims, which further comprises monitoring one or more metabolic disorders in a patient by applying the method of claim 1 to at least two urine samples collected from the patient at different times.

6. The method of any one of the preceding claims claim 1, wherein prior to the step of analyzing, the sample is centrifuged.

7. A method of screening for organic acid markers of metabolic disorders in a urine sample comprising:
i) providing a urine sample comprising at least 50 different nonderivitized organic acids, and
ii) chromatographing the sample on an HPLC column of an HPLC-MS-MS system such that effluent from the HPLC column is fed into the MS-MS portion of the system,
whereby the levels of at least 50 different organic acids can be measured in a single mass spectrometer run of the chromatographed sample.

8. The method of claim 7, wherein said measuring comprises measuring at least one representative ion peak for each organic acid.

9. The method of claim 8, wherein each representative ion peak is a parent ion or a daughter ion.

10. The method of any of the preceding claims wherein at least 40 of said different organic acids are markers of metabolic disorders, and the method further comprises comparing the measured level of at least one measured organic acid with a normal level, such that a non-normal level of a measured organic acid indicates the presence or status of a metabolic disorder.

11. The method of any of the preceding claims, which further comprises monitoring one or more metabolic disorders in a patient by applying the method of claim 1 to at least two urine samples collected from the patient at different times.

12. The method of any one of the preceding claims claim 7, wherein prior to the step of analyzing, the sample is centrifuged.

13. A system for detecting markers of metabolic disorders comprising:
i) an HPLC-MS-MS system; and
ii) a database comprising at least one ion peak of at least 50 organic acid markers for metabolic disorders.
